(19) United States
(12) Patent Application Publication
(10) Pub. No.: US 2024/0147409 A1
(43) Pub. Date: May 2, 2024

(54) LOCATION INFORMATION SENDING METHOD AND APPARATUS, DEVICE, AND STORAGE MEDIUM

(71) Applicant: BEIJING XIAOMI MOBILE SOFTWARE CO., LTD., Beijing (CN)

(72) Inventor: Xiaolong LI, Beijing (CN)

(73) Assignee: BEIJING XIAOMI MOBILE SOFTWARE CO., LTD., Beijing (CN)

(21) Appl. No.: 18/281,285

(22) PCT Filed: Mar. 12, 2021
(86) PCT No.: PCT/CN2021/080607

§ 371 Date: Sep. 8, 2023

(51) Int. Cl. H04W 64/00; H04W 48/04

(52) U.S. Cl. CPC H04W 64/00; H04W 48/04

(57) ABSTRACT

A location information sending method and apparatus, a device, and a storage medium. The method comprises: acquiring indication information that indicates an operation of a user terminal reporting location information; and reporting the location information of the user terminal in response to the indication information. In the method, after the indication information that indicates the operation of the user terminal reporting the location information is acquired, the location information is reported in response to the indication information. The location information is used by a base station to select a core network according to the location information, and/or the location information is used by the base station to form a Cell ID and sends the Cell ID to the core network.

### CROSS-REFERENCE TO RELATED APPLICATION

The present application is a U.S. National Stage of International Application No. PCT/CN2021/080607, filed on Mar. 12, 2021, the disclosure of which is incorporated herein by reference in its entirety for all purposes.

### BACKGROUND

In 5G NR, for an idle user terminal (UE) and an inactive UE, when a network has data to be sent to the UE, in order for the network to page the UE and send the data to the UE, concept of Registration Area (RA) is introduced. The Registration Area is defined as a set of Tracking Areas (TAs), and each TA includes one or more cells corresponding to a certain geographical region.

Specifically, each TA is determined by a TA identifier (TAI), and the TAI includes a Public Land Mobile Network (PLMN) and a Tracking Area Code (TAC). The network sends the PLMN and TAC to the UE by means of system message broadcast. The network UE can configure plurality of TAs for the UE, that is, the network configures a TAI list for the UE.

When the UE moves from TA1 to TA2, if TA2 is not in the TAI list configured by the network for the UE, the UE needs to initiate a Tracking Area Update (TAU) and/or Registration Area Update (RAU), so as to trigger the network to configure a new TAI list for the UE to ensure that the network can track the UE.

In addition, the network also broadcasts a Global Cell Identity (GCI). During the process of network attach/re-attach, TAU, etc., the UE will send to the network the TAC and/or GCI that is received through a system message.

### SUMMARY

The present disclosure relates to the technical field of wireless communication, and in particular to a method, apparatus, device, and storage medium for sending location information.

According to a first aspect of embodiments of the present disclosure, there is provided a location information sending method applied to a user terminal, the method including:
acquiring indication information that indicates the user terminal to perform an operation of reporting location information; and
in response to the indication information, reporting the location information of the user terminal.

According to a second aspect of the embodiments of the present disclosure, there is provided a location information sending method applied to a network side device, the method including:

sending, to a user terminal, indication information that indicates the user terminal to perform an operation of reporting location information.

According to a third aspect of the embodiments of the present disclosure, there is provided a location information sending device, including:
a processor; and
a memory configured to store instructions executable by the processor,
wherein the processor is configured to execute the executable instructions in the memory to carry out the steps of the location information sending method according to the first or second aspect.

### BRIEF DESCRIPTION OF THE DRAWINGS

The drawings described here are used to provide a further understanding of the embodiments of the present disclosure, and constitute a part of the present disclosure. The illustrative embodiments of the embodiments of the present disclosure and the descriptions thereof are used to explain the embodiments of the present disclosure, and do not constitute an improper limitation on the embodiments of the present disclosure. In the attached figures:

FIG. 1 is a flow chart showing a location information sending method according to an illustrative embodiment of the present disclosure.

FIG. 2 is a flow chart showing another location information sending method according to an illustrative embodiment of the present disclosure.

FIG. 3 is a flow chart showing still another location information sending method according to an illustrative embodiment of the present disclosure.

FIG. 4 is a flow chart showing still another location information sending method according to an illustrative embodiment of the present disclosure.

FIG. 5 is a flow chart showing still another location information sending method according to an illustrative embodiment of the present disclosure.

FIG. 6 is a flow chart showing still another location information sending method according to an illustrative embodiment of the present disclosure.

FIG. 7 is a flow chart showing still another location information sending method according to an illustrative embodiment of the present disclosure.

FIG. 8 is a flow chart showing still another location information sending method according to an illustrative embodiment of the present disclosure.

FIG. 9 is a flow chart showing still another location information sending method according to an illustrative embodiment of the present disclosure.

FIG. 10 is a flow chart showing still another location information sending method according to an illustrative embodiment of the present disclosure.

FIG. 11 is a flow chart showing still another location information sending method according to an illustrative embodiment of the present disclosure.

FIG. 12 is a flow chart showing still another location information sending method according to an illustrative embodiment of the present disclosure.

FIG. 13 is a flow chart showing still another location information sending method according to an illustrative embodiment of the present disclosure.

FIG. 14 is a flow chart showing still another location information sending method according to an illustrative embodiment of the present disclosure.

FIG. 15 is a flow chart showing still another location information sending method according to an illustrative embodiment of the present disclosure.

FIG. 16 is a structural diagram showing a location information sending apparatus according to an illustrative embodiment of the present disclosure.

FIG. 17 is a structural diagram showing another location information sending apparatus according to an illustrative embodiment of the present disclosure.

### DETAILED DESCRIPTION

Embodiments of the present disclosure are now further described in conjunction with the accompanying drawings and specific implementations.

Illustrative embodiments will be described in detail here, examples of which are illustrated in the accompanying drawings. When the following description refers to the accompanying drawings, the same numerals in different drawings represent the same or similar elements unless otherwise indicated. The implementations described in the following illustrative embodiments do not represent all implementations consistent with the embodiments of the present disclosure. Rather, they are merely examples of devices and methods consistent with some aspects of the present disclosure as detailed in the appended claims.

For a Non-terrestrial network (NTN) network, it has large coverage. At a border of different countries, one NTN cell may cover multiple countries. Then if the UE reports only the TAC and/or GO, the NTN network cannot determine the country where the UE is located based on the TAC and/or GCI reported by the UE, and thus the NTN network cannot select an appropriate attach strategy, such as whether to allow the user to attach, selecting an appropriate core network (users in different countries use the core networks of their corresponding countries), etc. Therefore, in addition to reporting TAC/GCI, the UE can also report UE location information, and the network determines the country where the UE is located according to the UE location information, so as to determine the appropriate strategy.

However, when the UE is not located at the border of different countries, the network can determine the country where the UE is located according to the GCI and/or TAC reported by the UE. In this case, the operation of the UE reporting its location information is unnecessary, and only increases the UE's power consumption and signaling overhead.

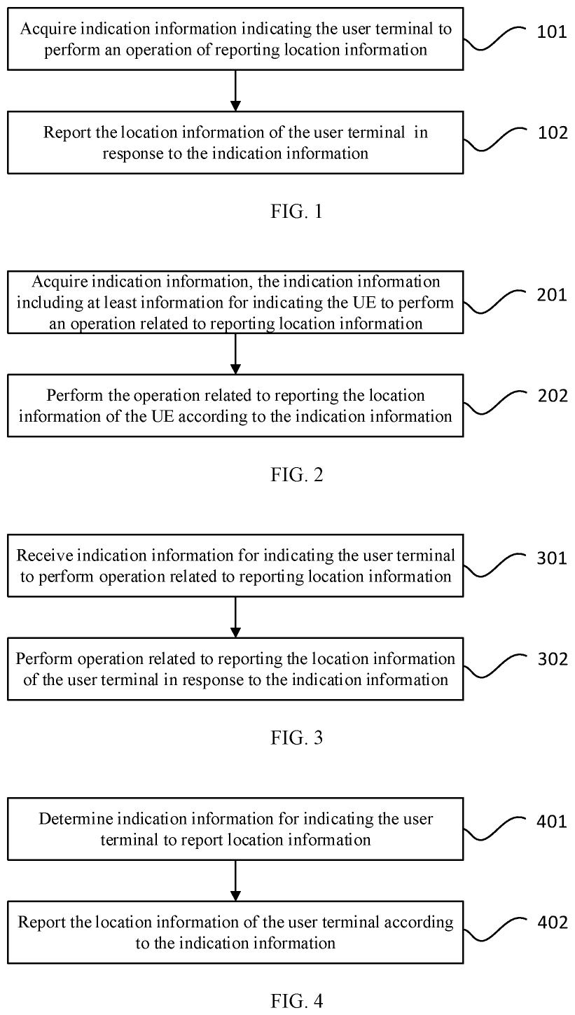

An illustrative embodiment of the present disclosure provides a location information sending method, the method is applied to a user terminal, and the user terminal may specifically be a UE. The embodiment of the present disclosure may be implemented alone or together with other embodiments of the present disclosure. In this method, the process of reporting location information by the UE is as shown in FIG. 1, including the following.

In step 101, indication information indicating the user terminal to perform an operation of reporting location information is acquired.

In this step, the UE acquires the indication information, and the indication information indicates the UE to perform reporting of the location information.

In step 102, the location information of the user terminal is reported in response to the indication information.

In this step, the UE reports its location information to a network side in response to the indication information.

In some embodiments of the present disclosure, the location information may be used for a base station to select a core network according to the location information.

In some embodiments of the present disclosure, the location information may be used for the base station to form a Cell ID using the location information and send it to the core network.

In some embodiments of the present disclosure, acquiring the indication information includes: receiving the indication information through a system message or dedicated signaling.

Another illustrative embodiment of the present disclosure provides a location information sending method, the method is applied to a user terminal, and the user terminal may specifically be a UE. The embodiment of the present disclosure may be implemented alone or together with other embodiments of the present disclosure. As shown in FIG. 2, the method includes the following.

In step 201, indication information is acquired, where the indication information includes at least information for indicating the UE to perform an operation related to reporting location information.

In step 202, the operation related to reporting the location information of the UE is performed according to the indication information.

In some embodiments of the present disclosure, the location information may be reported through MsgA, Msg3, Msg5, or other RRC Messages. Performing the operation related to reporting the location information of the UE may include determining to report the location information of the UE. Performing the operation related to reporting the location information of the UE may also include determining not to report the location information of the UE.

In some embodiments of the present disclosure, the indication information may include an information identity for indicating the UE to perform the operation related to reporting the location information. In a possible implementation, when the information identity is set to a first value, the indication information is used to indicate the UE to report the location information. In another possible implementation, when the information identity is set to a second value, the indication information is used to indicate the UE to report the location information.

In some embodiments of the present disclosure, the location information may be used for a base station to select a core network according to the location information.

In some embodiments of the present disclosure, the location information may be used for the base station to form a Cell ID using the location information and send it to the core network.

In some embodiments of the present disclosure, acquiring the indication information includes: receiving the indication information through a system message or dedicated signaling.

In some embodiments of the present disclosure, the dedicated signaling may include at least one of the following: Msg2, Msg4, MsgB, and a paging message. Specifically, the dedicated signaling may be any of the following signaling:
Msg2;
Msg4;
MsgB; and
a paging message.

Msg2 may specifically be a media access control random access response (MAC RAR), and the indication information is included in the MAC RAR.

In some embodiments of the present disclosure, the indication information includes at least one or more of the following information:

1. Location range information for which location information needs to be reported.

In some embodiments of the present disclosure, the location range information indicates at least one range. Specifically, it may indicate at least one geographic range, and precision of the geographic range may be set according to application requirements and device capabilities. For example, the geographic range is formed by GPS position coordinates.

The location range information may specifically be a physical cell identity (PCI) list, which includes at least one cell, and the cell list may be set according to application requirements and device capabilities.

In some embodiments of the present disclosure, when the UE is located within a range indicated by the location range information, it reports the location information.

2. TAC and/or GCI that triggers operation of reporting location information.

In some embodiments of the present disclosure, one or more specific TACs and/or GCIs are set to trigger the operation of reporting the location information. The specific TAC and/or GCI can be agreed by a protocol, or can be distributed and configured to the UE by the network side.

In some embodiments of the present disclosure, the UE reports the location information when receiving the above specific TAC and/or GCI.

3. An information identity for indicating the user terminal to perform operation of reporting location information.

In some embodiments of the present disclosure, an information identity for indicating the user terminal to perform operation of reporting the location information may be set.

For example, 1 bit in the system message and/or the RRC message is selected as the information identity, and it indicates the user terminal to report the location information through a value of the information identity. Specifically, the information identity with a value of 0 may be defined as no response being required, and the information identity with a value of 1 may be defined as indicating to report the location information. Alternatively, if there is no information identity in the system message and/or RRC message, the user terminal does not report the location information.

In some embodiments of the present disclosure, in a case where the value of the reports the location information.

In some embodiments of the present disclosure, the indication information or the system message carrying the indication information or the dedicated signaling carrying the indication information is not a positioning request for the UE, especially not a positioning request sent when positioning of the UE is performed, for example, a positioning request sent to UE by a Location Management Function (LMF) through an LTE positioning protocol (LPP) message.

An illustrative embodiment of the present disclosure provides a location information sending method; this embodiment may be implemented alone or together with other embodiments of the present disclosure. The location information of the user terminal includes at least one of the following: geographical location information of the user terminal, a distance between the user terminal and a center of a cell, a distance between the user terminal and a satellite, a cell within a signal receiving range of the user terminal, signal strength of a cell within the signal receiving range of the user terminal, signal quality of a cell within the signal receiving range of the user terminal, and a cell with the strongest signal within the signal receiving range of the user terminal.

In some embodiments of the present disclosure, the location information includes any one or more of the following information:
geographical location information of the user terminal;
a distance between the user terminal and a center of a cell;
a distance between the user terminal and a satellite;
a cell within a signal receiving range of the user terminal;
signal strength of a cell within the signal receiving range of the user terminal;
signal quality of a cell within the signal receiving range of the user terminal; and
a cell with the strongest signal within the signal receiving range of the user terminal (in some embodiments of the present disclosure, it may specifically be a cell ID of the cell with the strongest signal).

The geographical location information of the user terminal may specifically be a coordinate position obtained by the UE through global navigation satellite system (GNSS) positioning.

The signal strength may specifically be Reference Signal Received Power (RSRP).

The signal quality may specifically be Reference Signal Received Quality (RSRQ).

An illustrative embodiment of the present disclosure also provides a location information sending method; the method can be performed alone or together with other embodiments of the present disclosure. In some embodiments of the present disclosure, the UE receives the indication information used for indicating the user terminal to perform the operation related to reporting location information through a system message or dedicated signaling. The specific process is as shown in FIG. 3, including the following.

In step 301, indication information used for indicating the user terminal to perform an operation related to reporting location information is received.

In this step, the network-side device, such as a base station, sends the indication information to the user terminal to indicate the user terminal to perform the operation of reporting the location information. The user terminal may specifically be a UE.

In some embodiments of the present disclosure, the user terminal receives a system message, and the system message carries the indication information.

In some embodiments of the present disclosure, the user terminal receives dedicated signaling, and the dedicated signaling carries the indication information. The dedicated signaling can be any of the following:
Msg2;
Msg4;
MsgB; and
a paging message.

Msg2 may specifically be a media access control random access response (MAC RAR), and the indication information is included in the MAC RAR.

The indication information includes at least one or more of the following information:

1. Location range information for which location information needs to be reported.

In some embodiments of the present disclosure, the location range information can specifically indicate at least one range. In specific, it can indicate at least one geographic range, and precision of the geographic range may be set according to application requirements and device capabilities. For example, the geographic range is formed by GPS position coordinates.

The location range information may specifically be a physical cell identity (PCI) list, which includes at least one cell, and the cell list may be set according to application requirements and device capabilities.

In some embodiments of the present disclosure, when the UE is located within the range indicated by the location range information, it reports the location information.

2. TAC and/or GCI that triggers operation of reporting location information.

In some embodiments of the present disclosure, one or more specific TACs and/or GCIs are set to trigger the operation of reporting the location information. The specific TAC and/or GCI can be agreed by a protocol, or can be distributed and configured to the UE by the network side.

In some embodiments of the present disclosure, the UE reports the location information when receiving the above specific TAC and/or GCI.

3. An information identity for indicating the user terminal to perform an operation of reporting location information.

In some embodiments of the present disclosure, an information identity for indicating the user terminal to perform the operation of reporting the location information may be set.

For example, 1 bit in the system message and/or the RRC message is selected as the information identity, and it indicates the user terminal to report the location information through the value of the information identity. Specifically, the information identity with a value of 0 may be defined as no response being required, and the information identity with a value of 1 may be defined as indicating to report the location information.

In some embodiments of the present disclosure, in a case where the value of the reports the location information.

In some embodiments of the present disclosure, the indication information or the system message carrying the indication information or the dedicated signaling carrying the indication information is not a positioning request for the UE, especially not a positioning request sent when positioning of the UE is performed, for example, a positioning request sent to the UE by a Location Management Function (LMF) through an LTE positioning protocol (LPP) message.

In step 302, the operation related to reporting the location information of the user terminal is performed in response to the indication information.

In some embodiments of the present disclosure, the indication information may include an information identity for indicating the UE to perform the operation related to reporting the location information. In a possible implementation, when the information identity is set to a first value, the indication information is used to indicate the UE to report the location information. In another possible implementation, when the information identity is set to a second value, the indication information is used to indicate the UE to report the location information.

In some embodiments of the present disclosure, the location information may be used for a base station to select a core network according to the location information.

In some embodiments of the present disclosure, the location information may be used for the base station to form a Cell ID using the location information and send it to the core network.

In some embodiments of the present disclosure, the UE may report the location information of the user terminal through any one or more of the following messages:
MsgA;
Msg3;
Msg5; and
other RRC Messages.

In some embodiments of the present disclosure, the location information may be reported through MsgA, Msg3, Msg5, or other RRC Messages. Performing the operation related to reporting the location information of the UE may include determining to report the location information of the UE. Performing the operation related to reporting the location information of the UE may also include determining not to report the location information of the UE.

An illustrative embodiment of the present disclosure also provides a location information reporting method; the method can be performed alone or together with other embodiments of the present disclosure. In this method, the indication information is preset in the user terminal, and the user terminal can directly acquire the locally preset indication information, and report location information according to the indication information. The specific process is as shown in FIG. 4, including the following.

In step 401, indication information for indicating the user terminal to report location information is determined.

In this embodiment, the user terminal may specifically be a UE. In some embodiments of the present disclosure, the indication information is preset in the UE, and the UE may directly obtain the indication information preset locally. The preset indication information does not include an information identity, but may include location range information and/or a TAC and/or a GCI.

In some other embodiments of the present disclosure, the UE may determine the indication information according to a communication protocol. In some other embodiments of the present disclosure, the UE may determine the indication information according to a state and the communication protocol. The location information includes at least any one or more of the following information:

1. Location range information for which location information needs to be reported.

In some embodiments of the present disclosure, the location range information can specifically indicate at least one range. In specific, it can be at least one geographic range, and precision of the geographic range may be set according to application requirements and device capabilities. For example, the geographic range is formed by GPS position coordinates.

The location range information may specifically be a physical cell identity (PCI) list, which includes at least one cell, and the cell list may be set according to application requirements and device capabilities.

In some embodiments of the present disclosure, when the UE is located within the range indicated by the location range information, it reports the location information.

2. TAC and/or GCI that triggers operation of reporting location information.

In some embodiments of the present disclosure, one or more specific TACs and/or GCIs are set to trigger the operation of reporting the location information. The specific TAC and/or GCI can be agreed by a communication protocol, or can be distributed and configured to the UE by the network side.

In some embodiments of the present disclosure, the UE reports the location information when receiving the above specific TAC and/or GCI.

In some embodiments of the present disclosure, the configuration of the indication information in the UE can be updated. The update can be obtained remotely from the network side, or obtained from the user's operation on the UE.

In step 402, the location information of the user terminal is reported according to the indication information.

In this step, the UE reports its location information to the network side in response to the indication information.

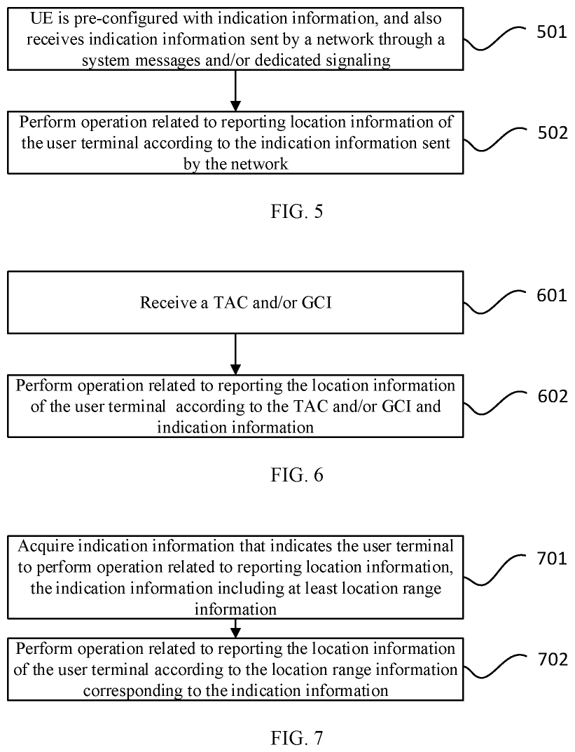

An illustrative embodiment of the present disclosure also provides a location information sending method, which is applied to a user terminal. The user terminal is specifically a UE. The method can be performed alone or together with other embodiments of the present disclosure. In this method, the UE receives indication information sent by the network in a case where the UE has been preset with indication information, selects the indication information to be applied and performs reporting in response to the selected indication information. The specific process is as shown in FIG. 5, including the following.

In step 501, the UE is pre-configured with indication information, and also receives indication information sent by a network through a system messages and/or dedicated signaling.

In step 502, an operation related to reporting location information of the user terminal is performed according to the indication information sent by the network.

In this step, the UE performs the operation related to reporting the location information of the user terminal according to the indication information sent by the network.

In some embodiments of the present disclosure, the UE is pre-configured with indication information and has also received indication information sent by the network, and the UE reports the location information of the user terminal in response to the indication information sent by the network. For example, the UE has been pre-configured with the location range information for which the location information needs to be reported, and has also received the indication information sent by the network that indicates the UE to report the location information, and even if the UE is not within the range indicated by the pre-configured location range information, the UE still needs to report its location information.

In some embodiments of the present disclosure, the UE saves one or more pieces of indication information received from the network side, and reports the location information of the user terminal in response to one or more of these pieces of indication information.

An illustrative embodiment of the present disclosure provides a location information sending method, which is applied to a user terminal, and the user terminal may specifically be a UE. The method can be performed alone or together with other embodiments of the present disclosure. In this method, the indication information is specifically a TAC and/or GCI. The process of reporting the location information by the UE is as shown in FIG. 6, including the following.

In step 601, a TAC and/or GCI is received.

In step 602, an operation related to reporting the location information of the user terminal is performed according to the TAC and/or GCI and indication information.

In some embodiments of the present disclosure, the TAC and/or GCI are received via a broadcast channel. The indication information is also a TAC and/or GO, the user terminal compares the received TAC and/or GCI with the indication information, and reports the location information of the user terminal when the TAC and/or GCI correspond to the indication information.

In some embodiments of the present disclosure, the user terminal can determine the indication information; for example, the user terminal is preset with the indication information, or the user terminal can determine the indication information according to an agreement by a communication protocol, or the user terminal can receive the indication information according to a system message and/or dedicated signaling.

In some embodiments of the present disclosure, it is agreed by the communication protocol that when the UE acquires some specific TACs and/or GCIs, the UE reports the location information, that is, when the TAC and/or GCI obtained by the UE from the network is the TAC and/or GCI agreed by the communication protocol, the UE reports the location information. In this way, the network does not need to additionally send the indication information, which reduces signaling overhead.

In some embodiments of the present disclosure, the location information may be reported through MsgA, Msg3, Msg5, or other RRC Messages. Performing the operation related to reporting the location information of the UE may include determining to report the location information of the UE. Performing the operation related to reporting the location information of the UE may also include determining not to report the location information of the UE.

An illustrative embodiment of the present disclosure provides a location information sending method, which is applied to a user terminal, and the user terminal may specifically be a UE. The method can be performed alone or together with other embodiments of the present disclosure. In this method, the indication information is specifically location range information. The process of reporting the location information by the UE is as shown in FIG. 7, including the following.

In step 701, indication information that indicates the user terminal to perform an operation related to reporting location information is acquired, where the indication information includes at least location range information.

In some embodiments of the present disclosure, the UE obtains the indication information through a system message or dedicated signaling. For the definition of the system message or dedicated signaling, reference may be made to the content in any embodiment of the present disclosure, which will not be repeated here.

In some embodiments of the present disclosure, the indication information is preset in the UE, and the UE acquires the indication information locally.

In some embodiments of the present disclosure, the UE determines the indication information through an agreement by a communication protocol.

In step 702, the operation related to reporting the location information of the user terminal is performed according to the location range information corresponding to the indication information.

In this step, the location range information in the indication information can determine at least one range. The location range information may specifically indicate at least one geographic range, and the precision of the geographic range may be set according to application requirements and device capabilities, for example, the geographic range is formed by GPS position coordinates. Specifically, the location range information may also be a PCI list, which includes at least one cell, and the cell list may be set according to application requirements and device capabilities.

In some embodiments of the present disclosure, the location information may be reported through MsgA, Msg3, Msg5, or other RRC Messages. Performing the operation related to reporting the location information of the UE may include determining to report the location information of the UE. Performing the operation related to reporting the location information of the UE may also include determining not to report the location information of the UE.

In an implementation, in response to that the UE is located within the above range, the UE reports the location information. In another implementation, in response to that the UE is not located within the above range, the UE does not report the location information.

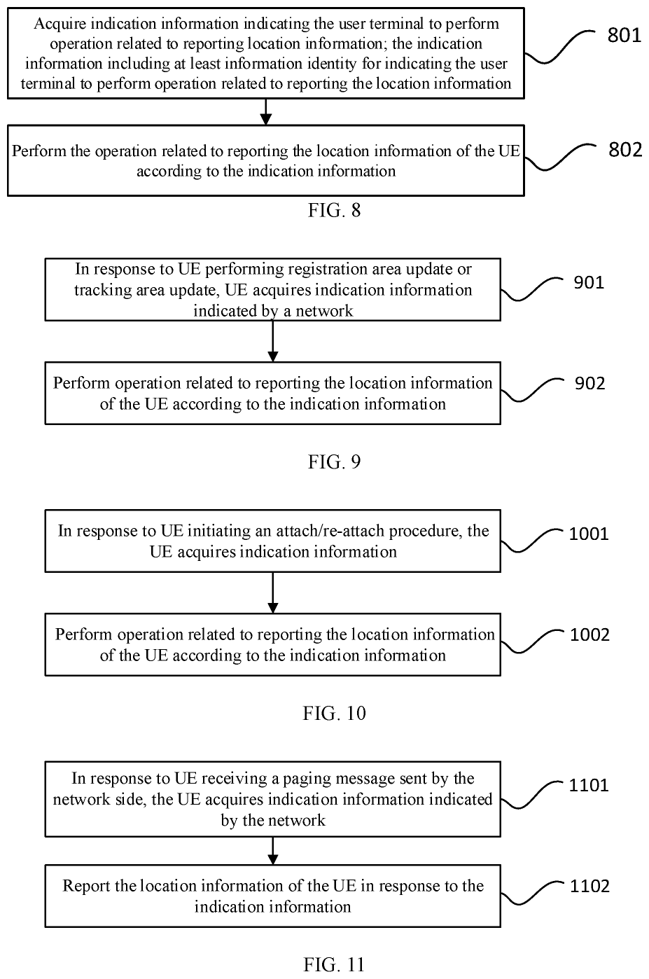

An illustrative embodiment of the present disclosure provides a location information sending method, which is applied to a user terminal, and the user terminal may specifically be a UE. The method can be performed alone or together with other embodiments of the present disclosure. In this method, the indication information is specifically an information identity. The process of reporting the location information by the UE is as shown in FIG. 8, including the following.

In step 801, indication information that indicates the user terminal to perform an operation related to reporting location information is acquired; where the indication information includes at least an information identity for indicating the user terminal to perform the operation related to reporting the location information.

In some embodiments of the present disclosure, the UE acquires the indication information from the network side through a system message or dedicated signaling.

In some embodiments of the present disclosure, the indication information may include an information identity for indicating the UE to perform the operation related to reporting the location information. In a possible implementation, when the information identity is set to a first value, the indication information is used to indicate the UE to report the location information.

In step 802, the operation related to reporting the location information of the UE is performed according to the indication information.

In this embodiment, the UE reports the location information during the attach/re-attach process. In some embodiments of the present disclosure, the location information may be reported through MsgA, Msg3, Msg5, or other RRC Messages. Performing the operation related to reporting the location information of the UE may include determining to report the location information of the UE. Performing the operation related to reporting the location information of the UE may also include determining not to report the location information of the UE.

An illustrative embodiment of the present disclosure provides a location information sending method, which is applied to a user terminal, and the user terminal may specifically be a UE. When the user terminal performs registration area update or tracking area update, it reports the location information of the user terminal. The method can be performed alone or together with other embodiments of the present disclosure. Specifically, the location information of the user terminal may be reported during the TAU process of the user terminal. The process of the method is as shown in FIG. 9, including the following.

In step 901, in response to the UE performing registration area update or tracking area update, the UE acquires indication information indicated by a network.

In the above step, there is no restriction on the execution order/slot of the UE performing the registration area update or tracking area update and the UE acquiring the indication information indicated by the network, that is, the two processes can be performed simultaneously or one after the other.

The above step may be as follows: UE enters cell 1 and obtains a TAC broadcast by the network side; in response to that the TAC is not in the TAI list configured by the network for the UE, the UE performs registration area update or tracking area update, specifically, RAU and/or TAU.

In some embodiments of the present disclosure, the UE acquires the indication information through a system message or dedicated signaling. For the definition of the system message or dedicated signaling, reference may be made to the content in any embodiment of the present disclosure, which will not be repeated here. For example, the indication information indicated by the network can be acquired through Msg2, Msg4, or MsgB.

In some embodiments of the present disclosure, the indication information is preset in the UE, and the UE acquires the indication information locally.

In some embodiments of the present disclosure, the UE determines the indication information through an agreement by a communication protocol.

In this step, after acquiring the indication information indicating to perform the operation of reporting the location information from the network side, the UE determines that it needs to report its location information during the RAU and/or TAU process.

In step 902, the operation related to reporting the location information of the UE is performed according to the indication information.

In this embodiment, the UE reports the location information during the TAU process. In some embodiments of the present disclosure, the location information may be reported through MsgA, Msg3, Msg5, or other RRC Messages. Performing the operation related to reporting the location information of the UE may include determining to report the location information of the UE. Performing the operation related to reporting the location information of the UE may also include determining not to report the location information of the UE.

An illustrative embodiment of the present disclosure provides a location information sending method, which is applied to a user terminal, and the user terminal may specifically be a UE. The method can be performed alone or together with other embodiments of the present disclosure. In the method, when the user terminal attaches/re-attaches to the network, the location information of the user terminal is reported. Specifically, the location information of the user terminal may be reported during the process of the user terminal being powered on and accessing the cell. The method can be performed alone or together with other embodiments of the present disclosure. In this method, the process of reporting location information by the UE is as shown in FIG. 10, including the following.

In step 1001, in response to UE initiating an attach/re-attach procedure, the UE acquires indication information.

In this step, the UE determines that it needs to report its location information during the process of attaching/re-attaching to the network according to the indication information acquired from the network side.

In some embodiments of the present disclosure, the UE acquires the indication information through a system message or dedicated signaling. For the definition of the system message or dedicated signaling, reference may be made to the content in any embodiment of the present disclosure, which will not be repeated here. For example, the indication information indicated by the network can be acquired through Msg2, Msg4, or MsgB.

In some embodiments of the present disclosure, the indication information is preset in the UE, and the UE acquires the indication information locally.

In some embodiments of the present disclosure, the UE determines the indication information through a communication standard.

In this step, after acquiring the indication information indicating to perform the operation of reporting location information from the network side, the UE determines that it needs to report its location information during the attach/re-attach process.

In step 1002, the operation related to reporting the location information of the UE is performed according to the indication information.

In this embodiment, the UE reports the location information during the attach/re-attach process. In some embodiments of the present disclosure, the location information may be reported through MsgA, Msg3, Msg5, or other RRC Messages. In this embodiment, the UE may perform the operation related to reporting the location information of the UE according to the indication information during the initial attach or any process of attaching/re-attaching to the network (for example, entering the active state from the inactive state). Performing the operation related to reporting the location information of the UE may include determining to report the location information of the UE. Performing the operation related to reporting the location information of the UE may also include determining not to report the location information of the UE.

An illustrative embodiment of the present disclosure provides a location information sending method, which is applied to a user terminal, and the user terminal may specifically be a UE. The method can be performed alone or together with other embodiments of the present disclosure. In this method, when the user terminal attaches/re-attaches to the network after receiving a paging message, the location information of the user terminal is reported. Specifically, for a user terminal that has been already in a certain cell, it initiates a process of attaching/re-attaching to the network after receiving a paging message sent by the network, and reports the location information of the user terminal during this process. In this method, the process of reporting location information by the UE is as shown in FIG. 11, including the following.

In step 1101, in response to UE receiving a paging message sent by the network side, the UE acquires indication information indicated by the network.

In some embodiments of the present disclosure, the UE acquires the indication information through a system message or dedicated signaling. For the definition of the system message or dedicated signaling, reference may be made to the content in any embodiment of the present disclosure, which will not be repeated here. For example, the indication information indicated by the network can be acquired through paging, Msg2, Msg4, or MsgB.

In some embodiments of the present disclosure, the indication information is preset in the UE, and the UE acquires the indication information locally.

In some embodiments of the present disclosure, the UE determines the indication information through a communication standard.

In this step, after acquiring the indication information indicating to perform the operation of reporting location information from the network side, the UE determines that it needs to report its location information during the process of attaching/re-attaching to the network in response to the paging.

In step 1102, the location information of the UE is reported in response to the indication information.

In this embodiment, the UE reports the location information during the attach/re-attach process. In some embodiments of the present disclosure, the location information may be reported through MsgA, Msg3, Msg5, or other RRC Messages. In this embodiment, the UE may perform the operation related to reporting the location information of the UE according to the indication information in the initial attach or during any process of attaching/re-attaching to the network (for example, entering the active state from the inactive state). Performing the operation related to reporting the location information of the UE may include determining to report the location information of the UE. Performing the operation related to reporting the location information of the UE may also include determining not to report the location information of the UE.

In any embodiment of the present disclosure, the indication information includes at least one or more of the following information:

1. Location range information for which location information needs to be reported.

In some embodiments of the present disclosure, the location range information may specifically indicate at least one geographic range, and precision of the geographic range may be set according to application requirements and device capabilities. For example, the geographic range is formed by GPS position coordinates.

The location range information may specifically be a PCI list, which includes at least one cell, and the cell list may be set according to application requirements and device capabilities.

In some embodiments of the present disclosure, when the UE is located within the range indicated by the location range information, it reports the location information.

2. TAC and/or GCI that triggers operation of reporting location information.

In some embodiments of the present disclosure, one or more specific TACs and/or GCIs are set to trigger the operation of reporting the location information. The specific TAC and/or GCI can be agreed by a protocol, or can be distributed and configured to the UE by the network side.

In some embodiments of the present disclosure, the UE reports the location information when receiving the above specific TAC and/or GCI.

3. An information identity for indicating the user terminal to perform operation of reporting location information.

In some embodiments of the present disclosure, an information identity for indicating the user terminal to perform the operation of reporting the location information may be set.

For example, 1 bit in the system message and/or the RRC message is selected as the information identity, and it indicates the user terminal to report the location information through a value of the information identity. Specifically, the information identity with the value of 0 may be defined as no response being required, and the information identity with the value of 1 may be defined as indicating to report the location information.

In some embodiments of the present disclosure, in a case where the value of the information identity indicates the user terminal to report the location information, the UE reports the location information.

In some embodiments of the present disclosure, the indication information or the system message carrying the indication information or the dedicated signaling carrying the indication information is not a positioning request for the UE, especially not a positioning request sent when positioning of the UE is performed, for example, positioning request sent to the UE by a location management function (LMF) through an LTE positioning protocol (LPP) message.

In any embodiment of the present disclosure, the location information includes one or more of the following information:
geographical location information of the user terminal;
a distance between the user terminal and a center of a cell;
a distance between the user terminal and a satellite;
a cell within a signal receiving range of the user terminal;
signal strength of a cell within the signal receiving range of the user terminal;
signal quality of a cell within the signal receiving range of the user terminal; and
a cell with the strongest signal within the signal receiving range of the user terminal (in some embodiments of the present disclosure, it may specifically be a cell ID of the cell with the strongest signal).

The geographical location information of the user terminal may specifically be a coordinate position obtained by the UE through global navigation satellite system (GNSS) positioning.

The signal strength may specifically be Reference Signal Received Power (RSRP).

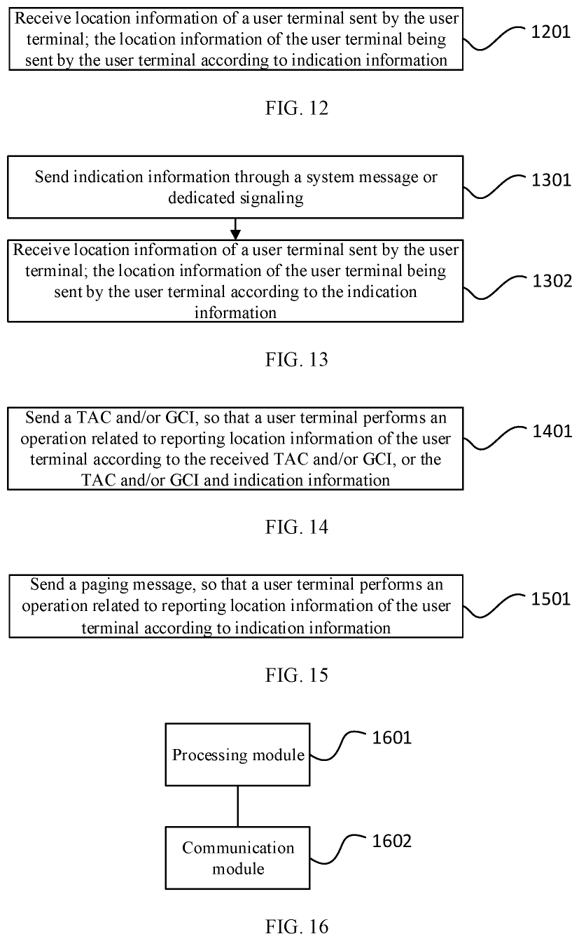

An illustrative embodiment of the present disclosure provides a location information processing method, which is applied to a network side device. The embodiment of the present disclosure may be performed alone or together with other embodiments of the present disclosure. The method flow is as shown in FIG. 12, including the following.

In step 1201, location information of a user terminal sent by the user terminal is received; where the location information of the user terminal is sent by the user terminal according to indication information.

In some embodiments of the present disclosure, the method further includes: selecting a corresponding core network according to the location information. That is, the network side device determines the core network that the user terminal attaches/re-attaches to according to the location information of the user terminal.

In some embodiments of the present disclosure, the method further includes: determining a Cell ID according to the location information and sending it to the core network.

In some embodiments of the present disclosure, the network side device may receive the location information reported by the UE through MsgA, Msg3, Msg5, or other RRC Messages.

An illustrative embodiment of the present disclosure provides a location information processing method, which is applied to a network side device. The embodiment of the present disclosure may be performed alone or together with other embodiments of the present disclosure. The method flow is as shown in FIG. 13, including the following.

In step 1301, the indication information is sent through a system message or dedicated signaling.

In step 1302, location information of a user terminal sent by the user terminal is received; where the location information of the user terminal is sent by the user terminal according to the indication information.

The user terminal may specifically be a UE. The indication information is sent to the UE by the network side device. In some embodiments of the present disclosure, the network side device sends the indication information through a system message or dedicated signaling. For the definition of the system message or dedicated signaling, reference may be made to the content in any embodiment of the present disclosure, which will not be repeated here. For example, the indication information may be sent through paging, Msg2, Msg4, or MsgB.

In some embodiments of the present disclosure, the user terminal receives the system message, and the system message carries the indication information.

In some embodiments of the present disclosure, the user terminal receives the dedicated signaling, and the dedicated signaling carries the indication information. The dedicated signaling can be any of the following:
Msg2;
Msg4;
MsgB; and
a paging message.

Msg2 may specifically be a media access control random access response (MAC RAR), and the indication information is included in the MAC RAR.

In some embodiments of the present disclosure, the UE is pre-configured with indication information and has also received the indication information sent by the network, and the UE reports the location information of the user terminal in response to the indication information sent by the network. For example, the UE has been pre-configured with the location range information for which the location information needs to be reported, and has also received the indication information sent by the network that indicates the UE to report the location information, and even if the UE is not within the range indicated by the pre-configured location range information, the UE still needs to report its location information.

An illustrative embodiment of the present disclosure provides a location information processing method, which is applied to a network side device. The embodiment of the present disclosure may be performed alone or together with other embodiments of the present disclosure. The method flow is as shown in FIG. 14, including the following.

In step 1401, a TAC and/or a GCI is sent, so that a user terminal performs an operation related to reporting location information of the user terminal according to the received TAC and/or GCI, and indication information. The user terminal may specifically be a UE.

In some embodiments of the present disclosure, the TAC and/or GCI are sent through a broadcast channel. In an implementation, the indication information is a TAC and/or GCI; and the network side broadcasts the TAC and/or GCI; the user terminal compares the TAC and/or GCI with the indication information, and when the TAC and/or GCI correspond to the indication information, it reports the location information of the user terminal.

In some embodiments of the present disclosure, the user terminal can determine the indication information in a number of ways; for example, the user terminal is preset with the indication information, or the user terminal can determine the indication information according to an agreement by a communication protocol, or the user terminal can receive the indication information according to a system message and/or dedicated signaling.

In some embodiments of the present disclosure, the location information may be reported through MsgA, Msg3, Msg5, or other RRC Messages. Performing the operation related to reporting the location information of the UE may include determining to report the location information of the UE. Performing the operation related to reporting the location information of the UE may also include determining not to report the location information of the UE.

An illustrative embodiment of the present disclosure provides a location information processing method, which is applied to a network side device. The embodiment of the present disclosure may be performed alone or together with other embodiments of the present disclosure. The method flow is as shown in FIG. 15, including the following.

In step 1501, a paging message is sent, so that a user terminal performs an operation related to reporting location information of the user terminal according to indication information.

In some embodiments of the present disclosure, the user terminal can determine the indication information in a number of ways; for example, the user terminal is preset with the indication information, or the user terminal can determine the indication information according to a communication standard, or the user terminal can receive the indication information according to a system message and/or dedicated signaling. The user terminal may specifically be a UE.

In some embodiments of the present disclosure, the location information may be reported through MsgA, Msg3, Msg5, or other RRC Messages. Performing the operation related to reporting the location information of the UE may include determining to report the location information of the UE. Performing the operation related to reporting the location information of the UE may also include determining not to report the location information of the UE.

An illustrative embodiment of the present disclosure provides a location information processing method, which is applied to a network side device. The embodiment of the present disclosure may be performed alone or together with other embodiments of the present disclosure. The method includes:

receiving location information of a user terminal sent by the user terminal during a RAU and/or TAU process of the user terminal, where the location information of the user terminal is sent by the user terminal according to indication information.

An illustrative embodiment of the present disclosure provides a location information processing method, which is applied to a network side device. The embodiment of the present disclosure may be performed alone or together with other embodiments of the present disclosure. The method includes:

receiving location information of a user terminal sent by the user terminal during a process of attaching/re-attaching to a network by the user terminal, where the location information of the user terminal is sent by the user terminal according to indication information.

In any of the above embodiments, the indication information includes at least location range information, so that the UE performs the operation related to reporting the location information of the user terminal according to a range corresponding to the indication information.

In this step, the location range information in the indication information can determine at least one range. The location range information may specifically indicate at least one geographic range, and the precision of the geographic range may be set according to application requirements and device capabilities, for example, the geographic range is formed by GPS position coordinates. Specifically, the location range information may also be a PCI list, which includes at least one cell, and the cell list may be set according to application requirements and device capabilities.

In some embodiments of the present disclosure, the location information may be reported through MsgA, Msg3, Msg5, or other RRC Messages. Performing the operation related to reporting the location information of the UE may include determining to report the location information of the UE. Performing the operation related to reporting the location information of the UE may also include determining not to report the location information of the UE.

In an implementation, in response to that the UE is located within the above range, the UE reports the location information. In another implementation, in response to that the UE is not located within the above range, the UE does not report the location information.

An illustrative embodiment of the present disclosure also provides a location information sending apparatus, which is applied to a user terminal. As shown in FIG. 16, the apparatus includes:
a processing module 1601, configured to acquire indication information that indicates the user terminal to perform an operation related to reporting location information; and
a communication module 1602, configured to perform the operation related to reporting the location information of the user terminal according to the indication information.

The manners for sending the location information by the location information sending apparatus is the same as those applied to the location information sending method by the user terminal.

In some implementations, the processing module 1601 is further configured to perform the steps of the method in any one of the above embodiments.

An illustrative embodiment of the present disclosure also provides a location information sending device, which is applied to a user terminal, the device including:
a processor; and
a memory configured to store instructions executable by the processor,
wherein the processor is configured to execute the executable instructions in the memory to carry out the steps of the location information sending method in any of the above embodiments.

An illustrative embodiment of the present disclosure also provides a non-transitory computer-readable storage medium having stored thereon executable instructions, wherein the executable instructions, when being executed by a processor, implement the steps of the location information sending method.

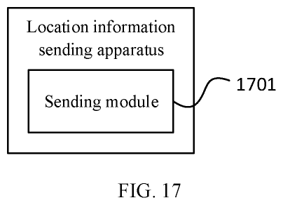

An illustrative embodiment of the present disclosure also provides a location information sending apparatus, which is applied to a network side device. As shown in FIG. 17, the apparatus includes:

a sending module 1701 configured to send, to a user terminal, indication information that indicates the user terminal to perform an operation of reporting location information.

The manner in which the sending module 1701 sends the indication information is the same as that applied to the location information sending method in the network side device.

An illustrative embodiment of the present disclosure also provides a location information sending device, which is applied to a network side device, the location information sending device including:
a processor; and
a memory configured to store instructions executable by the processor,
wherein the processor is configured to execute the executable instructions in the memory to carry out the steps of the location information sending method.

An illustrative embodiment of the present disclosure also provides a non-transitory computer-readable storage medium having stored thereon executable instructions, wherein the executable instructions, when being executed by a processor, implement the steps of the location information sending method.

The technical solutions provided by the embodiments of the present disclosure can include the following beneficial effects.

After the indication information indicating the user terminal to perform the operation of reporting the location information is acquired, the location information is reported in response to the indication information. The location information is used for the base station to select a core network according to the location information, and/or for the base station to form a Cell ID using the location information and send it to the core network. The user terminal determines whether it needs to report its location information according to the indication information, which reduces the power consumption of the user terminal and the signaling overhead of the network side, and provides a user terminal location information reporting mechanism with low resource consumption.

After considering the description and practicing the disclosure disclosed herein, those skilled in the art will readily contemplate other implementation of the embodiments of the present disclosure. The present disclosure is intended to cover any variations, uses, or adaptions of the embodiments of the present disclosure that conform to the general principles of the embodiments of the present disclosure and include common general knowledge or conventional technical means in the technical field which are not disclosed in the present disclosure. It is intended that the description and embodiments shall be considered as illustrative only, and the true scope and spirit of the embodiments of the present disclosure are specified by the appended claims.

The embodiments of the present disclosure are not limited to the precise structures that have been described above and shown in the accompanying drawings, and various modifications and changes can be made without departing from the scope thereof. The scope of the embodiments of the present disclosure is defined only by the appended claims.

### INDUSTRIAL APPLICABILITY

In the embodiments of the present disclosure, after the indication information indicating the user terminal to perform the operation of reporting the location information is acquired, the location information is reported in response to the indication information. The location information is used for the base station to select a core network according to the location information, and/or for the base station to form a Cell ID using the location information and send it to the core network. The user terminal determines whether it needs to report its location information according to the indication information, which reduces the power consumption of the user terminal and the signaling overhead of the network side, and provides a user terminal location information reporting mechanism with low resource consumption.

1. A location information sending method, comprising:
acquiring, by a user terminal, indication information that indicates the user terminal to perform an operation of reporting location information; and
in response to the indication information, reporting, by the user terminal, the location information of the user terminal.

2. The method according to claim 1, wherein the location information is used for a base station to select a core network based on the location information, or for the base station—to form a cell identity (ID) using the location information and sends the cell ID to a core network.

3. The method according to claim 1, wherein the indication information comprises location range information for which the location information needs to be reported, or
wherein the indication information comprises a Tracking Area Code (TAC) or a Global Cell Identity (GCI) that triggers the operation of reporting the location information, or
wherein the indication information comprises an information identity for indicating the user terminal to perform the operation of reporting the location information.

4.-5. (canceled)

6. The method according to claim 1, wherein acquiring the indication information comprises:
in response to that the user terminal performs registration area update or tracking area update, acquiring the indication information; or
in response to that the user terminal is powered on and attaches/re-attaches to a network, acquiring the indication information; or
in response to that the user terminal attaches/re-attaches to the network after receiving a paging message, acquiring the indication information.

7. The method according to claim 1, wherein the location information comprises any one or any combination of:
geographical location information of the user terminal;
a distance between the user terminal and a center of a cell;
a distance between the user terminal and a satellite;
a cell within a signal receiving range of the user terminal;
signal strength of a cell within a signal receiving range of the user terminal;
signal quality of a cell within a signal receiving range of the user terminal; or
a cell with a strongest signal within a signal receiving range of the user terminal.

8. The method according to claim 1, wherein the location information of the user terminal is reported through any one or any combination of:
a Random Access Message A (MsgA);
a Random Access Message 3 (Msg3);
a Random Access Message 5 (Msg5); or
other Radio Resource Control (RRC) messages.

9. The method according to claim 1, wherein acquiring the indication information that indicates the user terminal to perform the operation of reporting the location information comprises:
acquiring the indication information indicated by a network through a system message sent by the network.

10. The method according to claim 1, wherein acquiring the indication information that indicates the user terminal to perform the operation of reporting the location information comprises:
acquiring the indication information indicated by a network is acquired through dedicated signaling sent by the network, and the dedicated signaling comprises any one of:
a Random Access Message 2 (Msg2);
a Random Access Message 4 (Msg4);
a Random Access Message B (MsgB); and/or
a paging message.

11. The method according to claim 1, wherein acquiring the indication information that indicates the user terminal to perform the operation of reporting the location information comprises:
acquiring the indication information preset in the user terminal.

12. The method according to claim 11, wherein the indication information comprises a TAC or a GCI, and in response to the indication information, reporting the location information of the user terminal comprises:
in response to receiving the TAC or GCI broadcast by a network which is consistent with the indication information, determining that the location information of the user terminal needs to be reported.

13. A location information sending method, comprising:
sending, to a user terminal by a network, indication information that indicates the user terminal to perform an operation of reporting location information.

14. The method according to claim 13, wherein the location information is used for a base station to select a core network based on the location information, or for the base station to form a cell identity (ID) using the location information and send the cell ID to a core network.

15. The method according to claim 13, wherein the indication information comprises location range information for which the location information needs to be reported.

16. The method according to claim 13, wherein the indication information comprises a Tracking Area Code (TAC) or a Global Cell Identity (GCI) that triggers the operation of reporting the location information.

17. The method according to claim 13, wherein the indication information comprises an information identity for indicating the user terminal to perform the operation of reporting the location information.

18. The method according to claim 13, wherein sending the indication information comprises:
in response to that the user terminal performs registration area update or tracking area update, sending the indication information; or
in response to that the user terminal is powered on and attaches/re-attaches to the network, sending the indication information; or
in response to that the user terminal attaches/reattaches to the network after receiving a paging message, sending the indication information.

19.-20. (canceled)

21. The method according to claim 13, wherein sending to the user terminal the indication information that indicates the user terminal to perform the operation of reporting the location information comprises:
sending a system message to the user terminal, wherein the indication information is carried in the system message.

22. The method according to claim 13, wherein sending to the user terminal the indication information that indicates the user terminal to perform the operation of reporting the location information comprises:
sending dedicated signaling to the user terminal, wherein the indication information is carried in the dedicated signaling, and the dedicated signaling comprises any one of:
a Random Access Message 2 (Msg2);
a Random Access Message 4 (Msg4);
a Random Access Message B (MsgB); or
a paging message.

23.-24. (canceled)

25. A location information sending device, comprising:
a processor; and
a memory configured to store instructions executable by the processor,
wherein the processor is configured to execute the executable instructions in the memory to cause the location information sending device to:
acquire indication information that indicates a user terminal to perform an operation of reporting location information; and
in response to the indication information, report the location information of the user terminal.

26. (canceled)

27. A location information sending device, comprising:
a processor; and
a memory configured to store instructions executable by the processor,
wherein the processor is configured to execute the executable instructions in the memory to cause the location information sending device to perform the method according to claim 13.
